(19) United States
(12) Patent Application Publication
(10) Pub. No.: US 2026/0273921 A1
(43) Pub. Date: Sep. 17, 2026

(54) PRINTING DEVICE, PRINTING METHOD, AND PRINTING SYSTEM

(71) Applicant: MIMAKI ENGINEERING CO., LTD., Nagano (JP)

(72) Inventors: Ryuta Harayama, Nagano (JP); Soichiro Takehana, Nagano (JP); Takumi Ohashi, Nagano (JP)

(73) Assignee: MIMAKI ENGINEERING CO., LTD., Nagano (JP)

(21) Appl. No.: 19/166,054

(22) PCT Filed: Jun. 18, 2024
(86) PCT No.: PCT/JP2024/021949

§ 371 Date: Sep. 17, 2025

(30) Foreign Application Priority Data
Jun. 20, 2023 (JP) 2023-100643

(51) Int. Cl. B41J 2/005; B41J 2/21; B41J 11/00; B41J 11/02

(52) U.S. Cl. CPC B41J 2/0057; B41J 2/2117; B41J 11/00242; B41J 11/0085; B41J 11/02

(57) ABSTRACT

The present invention performs printing on a transfer medium in a more appropriate manner. This printing device 12, which performs printing by an inkjet method on a transfer medium 50 which is a medium for a transfer film, comprises: a head unit 102 which discharges ink to the transfer medium 50; a main scanning drive unit 108 which causes the head unit 102 to perform a main scanning operation; and a sub-scanning drive unit 110 which causes the head unit 102 to perform a sub-scanning operation. The head unit 102 includes a color head 202 which is a first inkjet head for discharging color ink, and a white ink head 204 which is a second inkjet head arranged with the position thereof in the sub-scanning direction shifted relative to the color head 202.

### TECHNICAL FIELD

The present invention relates to a printing device, a printing method, and a printing system.

### DESCRIPTION OF RELATED ART

Conventionally, a printing device that performs printing by a transfer method is known (for example, see Patent Literature 1). By transferring an image printed on a medium for transfer by the printing device to a transferred medium, images may be expressed on transferred media of various materials.

### RELATED ART

### Patent Literature

Patent Literature 1: Japanese Patent Application Laid-Open No. 2022-130110

### SUMMARY

### Technical Problem

When performing printing by a transfer method, a printing device may discharge ink of a predetermined color overlapping an image drawn with color ink on a medium for transfer. For example, it is conceivable to form a layer of white ink that becomes a background of an image after transfer by discharging white ink overlapping an image drawn with color ink. In this case, it is conceivable that printing speed decreases because it becomes needed to discharge white ink in addition to color ink. Therefore, conventionally, a printing device having a configuration capable of performing printing more appropriately on a medium for transfer has been desired. Therefore, the present invention aims to provide a printing device, a printing method, and a printing system that can solve the above problems.

### Solution to the Problem

As a printing device that performs printing on a medium for transfer, for example, an inkjet printer that performs printing by an inkjet method using an inkjet head can be suitably used. Also, when using an inkjet printer to form a layer of ink of a predetermined color such as white overlapping an image drawn with color ink, it becomes needed to discharge the ink such as white so as not to mix with the color ink on the medium. In this case, by using merely some nozzles in the nozzle row of the inkjet head, the printing speed may decrease.

More specifically, for example, in a printing device that performs printing on a medium by causing an inkjet head to perform a main scanning operation of discharging ink while moving relatively to the medium in a preset main scanning direction, when forming a layer of white ink overlapping an image drawn with color ink, it is conceivable to discharge white ink from a nozzle row that is at a position adjacent in the main scanning direction to the nozzle row that discharges ink for color ink. And, in this case, in order to perform printing so that mixing of color ink and white ink does not occur on the medium for transfer, so that the area where color ink is discharged and the area where white ink is discharged do not overlap, it is conceivable to use merely half of all nozzles for the nozzle row for color ink, and also use merely half of all nozzles for the nozzle row for white ink. However, when printing is performed by such a method, the printing speed decreases due to the reduction in the number of nozzles used.

In response to this, the inventors of the present application considered using an inkjet head for color ink and an inkjet head for a predetermined color such as white, and arranging the inkjet head for the color such as white with a position shifted in a direction orthogonal to the main scanning direction relative to the inkjet head for color ink. With this configuration, even when printing is performed using the entire nozzle row of each of the inkjet heads, color ink and ink such as white may be appropriately prevented from mixing on the medium. Moreover, in this way, a decrease in printing speed that occurs due to further use of ink such as white may be appropriately prevented, and printing on the transfer medium may be appropriately performed.

Furthermore, the inventors of the present application found features needed to obtain such effects through further intensive research, and arrived at the present invention. In order to solve the above problems, the present invention is a printing device which performs printing by an inkjet method on a film-shaped transfer medium, including: a head unit which discharges ink to the medium; a main scanning drive unit which causes the head unit to perform a main scanning operation of discharging ink while moving relatively to the medium in a preset main scanning direction; and a sub-scanning drive unit which causes the head unit to perform a sub-scanning operation of moving relatively to the medium in a sub-scanning direction orthogonal to the main scanning direction. The head unit includes a first inkjet head that discharges color ink which is ink of a predetermined colored color, and a second inkjet head arranged with a position shifted from the first inkjet head in the sub-scanning direction.

By arranging the first inkjet head and the second inkjet head with positions thereof shifted in the sub-scanning direction, the ink discharged by the second inkjet head may be prevented from mixing with the color ink on the medium. Moreover, in this way, a decrease in printing speed that occurs by using the second inkjet head may be prevented. In this configuration, the second inkjet head discharges, for example, white ink. With the configuration, the second inkjet head can appropriately form an ink layer that becomes a background after transfer. White ink can also be considered as an example of light reflective ink. Also, the ink layer formed with white ink can also be considered as a light reflective ink layer. The color of the ink discharged by the second inkjet head may be other than white. That is, the second inkjet head may use ink of a color determined according to the quality required for printing, the purpose of printing, etc.

When the first inkjet head and the second inkjet head are arranged with positions shifted in the sub-scanning direction, it is also conceivable to make the heating conditions for the medium different between the position facing the first inkjet head and the position facing the second inkjet head on the medium, or between the positions thereof and positions adjacent to the positions thereof. The printing device of the configuration further includes, for example, a platen and a heating means. The platen is an example of a member that supports the medium at a position facing the head unit. The heating means heats the medium via the platen by applying heat to the platen. When an area where the first inkjet head is able to discharge ink in the main scanning operation of one time is defined as a first discharge area, and an area where the second inkjet head is able to discharge ink in the main scanning operation of one time is defined as a second discharge area, it is conceivable that the heating means and the platen heat the medium by making temperature distribution in the first discharge area different from temperature distribution in the second discharge area, or making the temperature distribution in the first discharge area and the second discharge area different from temperature distribution in areas adjacent to the first discharge area and the second discharge area.

Here, regarding temperature distribution, when printing is performed using an inkjet head, ink that has landed on a medium normally spreads in a dot-like manner on the medium during the period until the ink is fixed to the medium. And the manner in which ink spreads on the medium can be influenced by the temperature of the medium. When a portion having a temperature different from the surroundings (for example, a portion having a locally low temperature or the like) occurs on the medium, unevenness may occur in the dot spreading manner, and print quality may deteriorate. Such a problem of unevenness is considered to be particularly likely to become a problem when drawing an image with color ink. Therefore, regarding heating conditions for the medium, it is conceivable to make the temperature distribution in the first discharge area distribution in which unevenness or the like is less likely to occur than the temperature distribution in the second discharge area. For example, it is conceivable to reduce portions where temperature becomes locally low in the temperature distribution of the first discharge area compared to the temperature distribution in the second discharge area. That is, it is conceivable to make the temperature distribution of the first discharge area more uniform distribution than the temperature distribution in the second discharge area.

Also, in this configuration, the sub-scanning drive unit moves the head unit relatively to the medium by transporting the medium in a transport direction parallel to the sub-scanning direction. The sub-scanning drive unit, for example, transports the medium between main scanning operations, thereby changing the range on the medium that faces the head unit in the next main scanning operation. In this case, the second inkjet head is arranged on a downstream side in the transport direction with respect to the first inkjet head. With the configuration, an ink layer formed of ink discharged from the second inkjet head can be appropriately formed on an ink layer formed of color ink discharged from the first inkjet head. Also, in this case, for example, it is conceivable to use the platen in which suction holes for suctioning the medium are formed. In this case, it is conceivable that the platen does not perform suction of the medium during transport of the medium, and suctions the medium through the suction holes during the main scanning operation. With the configuration, the medium can be held more appropriately during the main scanning operation. However, in this case, it is conceivable that the positions of the suction holes in the platen cause a temperature difference with the surroundings due to differences in thermal conductivity compared to the surroundings. More specifically, it is conceivable that the temperature at the positions of the suction holes decreases compared to the surroundings, causing unevenness in the printing result.

In contrast, in order to perform printing with higher quality, it is conceivable to reduce the number of the suction holes in a range overlapping with the first discharge area as much as possible. More specifically, for example, when the number of the suction holes per unit area is defined as a suction hole density, it is conceivable to make the suction hole density in a range overlapping with the first discharge area smaller than the suction hole density in a range overlapping with the second discharge area. By making the suction hole densities different, the temperature distribution in the first discharge area and the temperature distribution in the second discharge area may be made different for the heating means and the platen. By reducing the suction hole density in the range overlapping with the first discharge area, unevenness due to the influence of the suction holes in images drawn with color ink may be made less likely to occur. In this way, printing with high quality can be performed. Moreover, it is more preferable not to form suction holes in the range overlapping with the first discharge area. For example, it is conceivable not to form suction holes in the range overlapping with the first discharge area of the platen, and to form suction holes in the range overlapping with the second discharge area. By configuring in this way, unevenness due to the influence of suction holes may be more appropriately prevented from occurring in images drawn with color ink.

Also, the configuration that reduces the suction hole density in the range overlapping with the first discharge area can be suitably used in printing devices and the like that perform printing on media other than film-shaped transfer media. For example, a printing device which performs printing by an inkjet method includes: a head unit which discharges ink to a medium; a main scanning drive unit which causes the head unit to perform a main scanning operation of discharging ink while moving relatively to the medium in a preset main scanning direction; a sub-scanning drive unit which causes the head unit to perform a sub-scanning operation of moving relatively to the medium in a sub-scanning direction orthogonal to the main scanning direction; a platen which supports the medium at a position facing the head unit; and a heating means which heats the medium via the platen by applying heat to the platen. The head unit includes a first inkjet head and a second inkjet head arranged with a position shifted from the first inkjet head in the sub-scanning direction, the sub-scanning drive unit moves the head unit relatively to the medium by transporting the medium in a transport direction parallel to the sub-scanning direction, and suction holes for suctioning the medium are formed in the platen. When an area where the first inkjet head is able to discharge ink in the main scanning operation of one time is defined as a first discharge area, an area where the second inkjet head is able to discharge ink in the main scanning operation of one time is defined as a second discharge area, and the number of the suction holes per unit area is defined as a suction hole density, the suction hole density in the range overlapping with the first discharge area is smaller than the suction hole density in the range overlapping with the second discharge area, such a printing device can be considered. Also, as configurations of the present invention, it is conceivable to use a printing method or printing system and the like having the same features as above. The printing system may further include a powder coating device and a transfer device in addition to the printing device. In these cases as well, the same effects as above can be obtained.

### Effects

According to the present invention, printing on a medium for transfer can be performed more appropriately.

### BRIEF DESCRIPTION OF THE DRAWINGS

FIG. 1 is a diagram for describing a printing system 10 including a printing device 12 according to an embodiment of the present invention. FIG. 1(a) shows an example of the configuration of the printing system 10. FIG. 1(b) shows an example of a printing operation executed in the printing system 10.

FIG. 2 is a diagram for describing the printing device 12 in more detail. FIG. 2(a) shows an example of the configuration of the printing device 12. FIG. 2(b) shows an example of the configuration of a head unit 102 in the printing device 12.

FIG. 3 is a diagram showing an example of a more specific configuration of the printing device 12.

FIG. 4 is a diagram for describing features of the head unit 102 and modified examples of the configuration of the head unit 102. FIG. 4(a) and (b) are diagrams for describing printing operations when using the head unit 102 having a configuration different from the head unit 102 of the example. FIG. 4(c) shows a modified example of the configuration of the head unit 102.

FIG. 5 is a diagram for describing a method of forming suction holes 312 in the platen 104. FIG. 5(a) shows an example of the configuration of the platen 104. FIG. 5(b) shows another example of the configuration of the platen 104.

FIG. 6 is a schematic diagram showing another disposition example of the suction holes 312.

### DESCRIPTION OF EMBODIMENTS

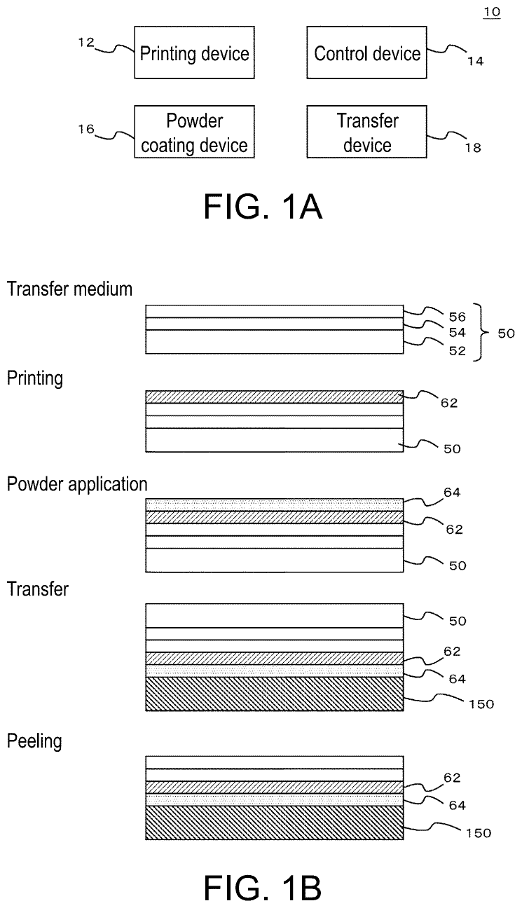

Hereinafter, embodiments according to the present invention will be described with reference to the drawings. FIG. 1 is a diagram for describing a printing system 10 including a printing device 12 according to an embodiment of the present invention. FIG. 1(a) shows an example of the configuration of the printing system 10. Except for the points described below, the printing system 10 and each of configurations of the printing system 10 may have the same or similar features as known printing systems and configurations thereof. The printing system 10 of the example is a printing system that performs printing by a transfer method, and includes a printing device 12, a control device 14, a powder coating device 16, and a transfer device 18. Transfer printing is a printing method that creates a final product of printing by transferring an image drawn on a transfer medium 50, which is a medium for transfer, to a transferred medium 150, which is another medium.

Among the configuration of the printing system 10 in the example, the printing device 12 is an inkjet printer that draws an image on the transfer medium 50, and draws an image on the transfer medium 50 by performing printing by the inkjet method. The transfer medium 50 is an example of an object to be printed by the printing device 12. As the transfer medium 50 of the example, for example, a film medium for transfer is used. In this case, the printing device 12 can also be considered as a direct to film (DTF) printer that performs direct printing on the film-shaped transfer medium 50. Also, the printing device 12 executes the operation of printing on the transfer medium 50 based on print data supplied from the control device 14. As the transfer medium 50, a known film for transfer can be suitably used. The transfer medium 50 can also be considered as a transfer sheet or the like. The configuration of the printing device 12 will be described in more detail later. Also, the control device 14 is a device that controls the operation of the printing device 12. The control device 14 of the example controls the operation of the printing device 12 by supplying print data showing an image to be printed on the transfer medium 50. As the control device 14, a computer or the like that executes a program for controlling the operation of the printing device 12 can be suitably used. The control device 14 may further perform control over other devices in the printing system 10.

The powder coating device 16 is a device (powdering device) that applies (gives) powder to the transfer medium 50 after an image has been drawn by the printing device 12. The powder is an example of adhesive powder for transfer. As the powder coating device 16, a known device for powder application used in transfer printing can be suitably used. Also, as the powder, known powder used in transfer printing can be suitably used. As the powder, for example, resin powder or the like that develops adhesiveness by melting when heated can be suitably used. The powder used in the powder coating device 16 can also be considered as an adhesive member or the like for adhering the transfer medium 50 to the transferred medium 150.

The transfer device 18 is a device that transfers an image drawn on the transfer medium 50 to which powder has been applied to the transferred medium 150. As the transfer device 18, a known device for transfer used in transfer printing can be suitably used. The transfer device 18 of the example thermally transfers the image drawn on the transfer medium 50 to the transferred medium 150 by applying pressure while heating the transfer medium 50 and the transferred medium 150 in a state where the transfer medium 50 and the transferred medium 150 are stacked such that the surface of the transfer medium 50 to which powder is applied contacts the transferred medium 150. Further, by peeling off the transfer medium 50 from the transferred medium 150 after the temperature of the transfer medium 50 and the transferred medium 150 has decreased, the transfer of the image to the transferred medium 150 is completed. According to the example, transfer printing can be appropriately performed using the transfer medium 50 and the transferred medium 150.

Furthermore, the specific configuration of the printing system 10 is not limited to the configuration shown in FIG. 1(a), and various modifications may also be made. For example, the printing system 10 may further include devices other than the devices described above. Regarding the multiple devices in the configuration shown in FIG. 1(a), the devices may be realized by one unit having the functions of the devices. Also, it is conceivable that some of the devices constituting the printing system 10 may be installed at different locations from other devices. For example, the printing device 12, control device 14, and powder coating device 16 may be installed at the same location (for example, the same factory or the like), and the transfer device 18 may be installed at a location separate from the printing device 12 or the like (for example, a different factory or the like).

Next, the printing operation and the like executed in the printing system 10 will be described in more detail. The printing system 10 of the example is considered to execute a transfer printing operation, for example, as shown in FIG. 1(b). FIG. 1(b) shows an example of a printing operation executed in the printing system 10.

When executing a transfer printing operation using the printing system 10, first, the transfer medium 50 is prepared as an object to be printed by the printing device 12. As the transfer medium 50 in the example, a sheet-shaped medium having a film layer 52, a peeling layer 54, and a receptor layer 56 is used. As the film layer 52, the peeling layer 54, and the receptor layer 56, layers identical or similar to each of layers in known transfer media can be suitably used. The film layer 52 is an example of a thin film-shaped configuration that serves as a substrate (base) in the transfer medium 50. As the film layer 52, layers composed of various resins can be suitably used. The film layer 52 of the example supports the receptor layer 56 via the peeling layer 54. The peeling layer 54 is a layer that releasably bonds the film layer 52 and the receptor layer 56. The peeling layer 54 can also be considered as a layer for separating the receptor layer 56 from the transfer medium 50 when peeling off the transfer medium 50 that is in close contact with the transferred medium 150. As the peeling layer 54, for example, a layer composed of a fluorine-based or silicon-based release agent can be suitably used. The receptor layer 56 is a layer that receives transfer ink discharged by the printing device 12. The receptor layer 56 is an example of a layer having a material or structure that easily adsorbs transfer ink. Also, as the receptor layer 56, for example, a layer composed of a porous material can be suitably used.

Also, the printing device 12 of the example performs printing using transfer ink on the transfer medium 50 as described above, thereby forming an ink layer 62 on the transfer medium 50. Forming the ink layer 62 on the transfer medium 50 is an example of forming the ink layer 62 on a predetermined surface of the transfer medium 50 while appropriately causing the receptor layer 56 of the transfer medium 50 to receive ink. The ink layer 62 is formed on the surface or inside of the receptor layer 56. Also, the printing device 12 may form multiple ink layers on the transfer medium 50. The printing device 12 may, for example, draw an image on the transfer medium 50 using transfer color ink, and form a layer of ink of a predetermined color such as white thereon. In this case, it is conceivable to cause the layer of ink of a predetermined color such as white to function as a background of the image after transfer. In this case, FIG. 1(b) can be considered to illustrate multiple ink layers collectively as the ink layer 62 for convenience of illustration.

After the printing device 12 forms the ink layer 62 on the transfer medium 50, the powder coating device 16 applies powder. In this way, the powder coating device 16 further forms a powder layer 64 on the ink layer 62 on the transfer medium 50. After the powder layer 64 is formed, the transfer device 18 executes transfer (thermal transfer). The transfer device 18, for example as shown in the figure, stacks the transfer medium 50 and the transferred medium 150 in a state where the powder layer 64 of the transfer medium 50 is in contact with the transferred medium 150, and by adding heat and pressure, melts the powder for adhesion of the powder layer 64. After that, by stopping the heating, the powder layer 64 and the like are cooled, the powder solidifies, and the transfer medium 50 is adhered to the transferred medium 150.

After the transfer device 18 adheres the transfer medium 50 to the transferred medium 150, the transfer medium 50 is peeled off (peeling) from the transferred medium 150. At this time, with the transfer medium 50 and the transferred medium 150 in an overlapped state, the film layer 52 is separated at the peeling layer 54, in which the film layer 52 becomes a portion outside the peeling layer 54 in the transfer medium 50, whereby the film layer 52 of the transfer medium 50 is peeled off. As a result, the portion corresponding to the receptor layer 56 in the transfer medium 50, and the ink layer 62 and the powder layer 64 remain on the side of the transferred medium 150. Then, by the ink layer 62 moving onto the transferred medium 150, the image drawn with color ink in the ink layer 62 is transferred to the transferred medium 150.

Moreover, according to the printing system 10 of the example, a medium that is difficult to directly print with the printing device 12 may be used as the transferred medium 150. More specifically, as the transferred medium 150, for example, a cloth medium or the like can be suitably used. As the cloth medium, for example, it is conceivable to use clothing such as nylon clothing and the like or towels and the like. As clothing, for example, it is conceivable to use T-shirt and the like. When performing transfer printing, printing can be performed more easily on media of various shapes. Therefore, as the transferred medium 150, for example, it is also conceivable to use media of various shapes such as an enamel bag or rain umbrella. Thus, according to the example, transfer printing can be appropriately performed on various transferred media 150.

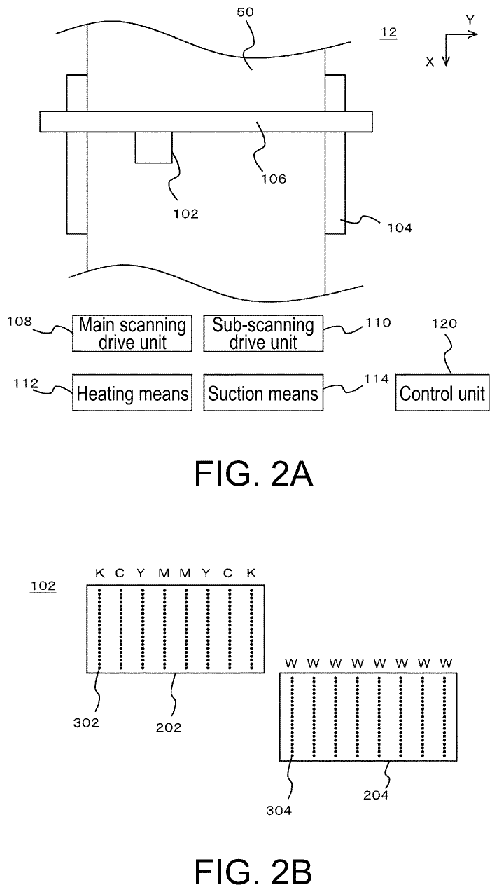

Next, the configuration and the like of the printing device 12 will be described in more detail. FIG. 2 is a diagram for describing the printing device 12 in more detail. FIG. 2(a) shows an example of the configuration of the printing device 12. FIG. 2(b) shows an example of the configuration of a head unit 102 in the printing device 12. The printing device 12 of the example includes the head unit 102, a platen 104, a Y bar unit 106, a main scanning drive unit 108, a sub-scanning drive unit 110, a heating means 112, a suction means 114, and a control unit 120. The printing device 12 may further include configurations identical or similar to configurations in known inkjet printers, in addition to the illustrated configurations.

The head unit 102 is a portion having an inkjet head that discharges ink to the transfer medium 50. As the ink discharged from the head unit 102, known transfer ink can be suitably used. The ink in the example uses evaporation drying type ink. The evaporation drying type ink is an example of ink that is fixed to a medium (transfer medium 50 or the like) by drying the ink. Also, the head unit 102 has, as an inkjet head, for example, as shown in FIG. 2(b), a color head 202 and a white ink head 204. The head unit 102 may further have a carriage or the like that holds the color head 202 and the white ink head 204. To simplify illustration and description, FIG. 2(b) illustrates a configuration in which the head unit 102 has one color head 202 and one white ink head 204. Also, the head unit 102 may have multiple color heads 202 and multiple white ink heads 204. The configuration in which the head unit 102 has multiple color heads 202 and the like will be described later as a modified example.

The color head 202 is an example of a first inkjet head, and discharges color ink which is ink of a predetermined colored color. The color head 202 of the example has multiple nozzle rows 302, and from the nozzle rows 302, discharges ink of black color (K color), cyan color (C color), yellow color (Y color), and magenta color (M color) as color ink. The ink of each of the colors of KCYM is an example of ink of each of colors of process colors which are basic colors of color expression. Also, the color head 202 of the example has eight nozzle rows 302, and for example, as shown in the figure, discharges ink from two of the nozzle rows 302 for one color. A nozzle row is a row in which multiple nozzles are arranged with positions shifted in a predetermined nozzle row direction. The nozzle row direction of the example is a direction parallel to a sub-scanning direction (X direction in the figure) preset in the printing device 12. Also, the nozzle rows 302 of the color head 202 are arranged in the main scanning direction orthogonal to the sub-scanning direction, with positions aligned in the sub-scanning direction.

The white ink head 204 is an example of a second inkjet head, and discharges white ink which is an example of spot color ink. Spot color ink is ink of a color different from each of the colors of process colors. As the white ink head 204, an inkjet head having the same structure as the color head 202 can be suitably used. The white ink head 204 of the example has eight nozzle rows 304 identical or similar to the nozzle rows 302 of the color head 202, and discharges white ink from the nozzle rows 304.

Also, the white ink head 204 of the example is arranged with a position shifted in the sub-scanning direction relative to the color head 202. Shifting the positions of the color head 202 and the white ink head 204 in the sub-scanning direction means shifting the nozzle row 302 of the color head 202 and the nozzle row 304 of the white ink head 204 so that the positions thereof in the sub-scanning direction do not overlap. In this case, for example, as shown in the figure, it is conceivable to also shift the position of the white ink head 204 in the main scanning direction from the position of the color head 202. Regarding the disposition of the color head 202 and the white ink head 204, it can be considered that the two inkjet heads (2 heads) are in a staggered arrangement. The printing operation performed using the color head 202 and white ink head 204 in such a disposition will be described in more detail later.

The platen 104 is a platform-shaped support member that supports the transfer medium 50 at a position facing the head unit 102. The platen 104 of the example has suction holes formed therein for suctioning the transfer medium 50. In this way, the platen 104 suctions and holds the transfer medium 50 as necessary. The Y bar unit 106 is a member that extends in the main scanning direction and holds the head unit 102 so as to be movable in the main scanning direction. In this way, the Y bar unit 106 guides the movement of the head unit 102 during a main scanning operation. The main scanning operation is an operation of discharging ink while moving relatively with respect to the transfer medium 50 in the main scanning direction. The main scanning drive unit 108 is a drive unit that causes the head unit 102 to perform the main scanning operation. Causing the head unit 102 to perform the main scanning operation can also be considered as causing the color head 202 and the white ink head 204, which are inkjet heads that the head unit 102 has, to perform the main scanning operation. The main scanning drive unit 108 of the example causes the head unit 102 to perform the main scanning operation by moving the head unit 102 along the Y bar unit 106 while causing the color head 202 and the white ink head 204 to discharge ink.

The sub-scanning drive unit 110 is a drive unit that causes the head unit 102 to perform a sub-scanning operation. The sub-scanning operation is an operation of moving relatively to the transfer medium 50 in the sub-scanning direction. Causing the head unit 102 to perform the sub-scanning operation can also be considered as causing the color head 202 and the white ink head 204 of the head unit 102 to perform the sub-scanning operation. The sub-scanning drive unit 110 of the example moves the head unit 102 relatively to the transfer medium 50 by transporting the transfer medium 50 in the transport direction parallel to the sub-scanning direction. Also, the sub-scanning drive unit 110 transports the transfer medium 50 between main scanning operations, thereby changing the range on the transfer medium 50 that faces the head unit 102 in the next main scanning operation. Regarding the relationship between the disposition of the color head 202 and the white ink head 204 in the head unit and the transport direction, the white ink head 204 of the example is arranged on the downstream side in the transport direction with respect to the color head 202. By configuring in this way, an ink layer formed of white ink discharged from the white ink head 204 can be appropriately formed on an ink layer formed of color ink discharged from the color head 202. The heating means 112 is a means for performing heating to fix ink to the transfer medium 50. The heating means 112 of the example heats the transfer medium 50 via the platen 104 by applying heat to the platen 104. The heating means 112 has a heater arranged on the side opposite to the head unit 102 side of the platen 104, and heats the transfer medium 50 via the platen 104 by transmitting heat of the heater to the platen 104. As such a heater, a known heater can be suitably used.

The suction means 114 is a means for suctioning the transfer medium 50 via suction holes of the platen 104. As the suction means 114, a known pump or the like can be suitably used. The suction means 114 of the example switches suction on and off according to control of the control unit 120, thereby causing the transfer medium 50 to be suctioned to the suction holes of the platen 104 at predetermined timing. More specifically, the suction means 114, for example, turns suction off during execution of the sub-scanning operation and turns suction on during execution of the main scanning operation. With this configuration, transport of the transfer medium 50 can be performed more easily and appropriately during the sub-scanning operation, while the transfer medium 50 can be held more reliably on the platen 104 during the main scanning operation. Also, it can be considered that the platen 104 does not perform suction of the transfer medium 50 during transport of the transfer medium 50, and suctions the transfer medium 50 through the suction holes during the main scanning operation. The control unit 120 is a configuration including a CPU of the printing device 12, and controls operation of each of parts of the printing device 12.

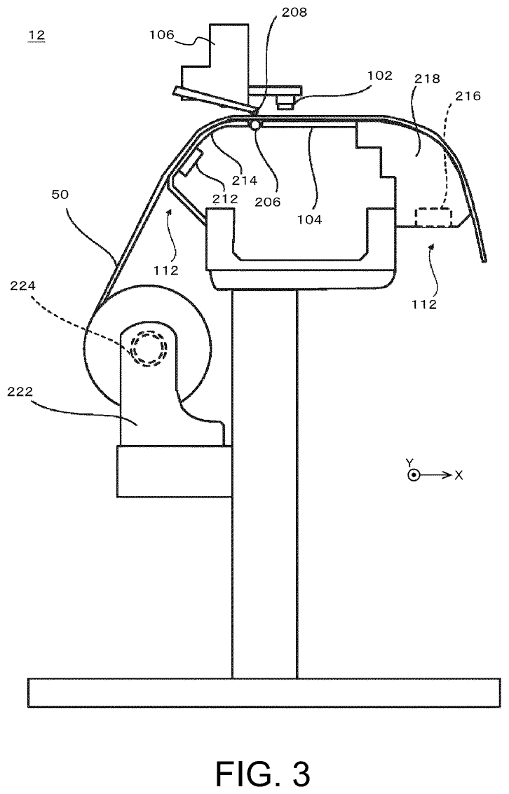

Here, FIG. 2 mainly illustrates an example of the configuration of the printing device 12, focusing on the functional configuration of the printing device 12. In contrast, when focusing on the specific structure of the printing device 12, it is conceivable to configure the printing device 12 as shown in FIG. 3, for example. FIG. 3 shows an example of a more specific configuration of the printing device 12. For convenience of illustration and description, in FIG. 3, a part of the functional configuration shown in FIG. 2 is omitted, and a part of the configuration of the printing device 12 that was omitted in FIG. 2 is illustrated. For example, the printing device 12 illustrated in FIG. 3 uses the transfer medium 50 wound in a roll shape on a paper tube 224. As a configuration for that purpose, the printing device 12 includes a roll holder 222. The roll holder 222 is an example of a member that rotatably holds the paper tube 224 around which the transfer medium 50 is wound. The printing device 12 sequentially feeds out the transfer medium 50 wound on the paper tube 224, transports the transfer medium 50 to a position facing the head unit 102, and performs printing on the transfer medium 50. Also, the printing device 12 includes a transport roller 206 and a pinch roller 208 as a configuration for transporting the transfer medium 50. The transport roller 206 is a roller that moves the transfer medium 50 by rotation. Also, the pinch roller 208 is a driven roller that sandwiches the transfer medium 50 between itself and the transport roller 206. The sub-scanning drive unit 110 (see FIG. 2) moves the transfer medium 50 in the transport direction by rotating the transport roller 206.

In this configuration, the heating means 112 (see FIG. 2) has multiple heaters 212 and 216 and multiple heated members 214 and 218. The heater 212 is a heater (preheater or rear heater) arranged on the upstream side of the head unit 102 in the transport direction of the transfer medium 50. The heated member 214 is a member heated by the heater 212, and by contacting the transfer medium 50, transmits the heat of the heater 212 to the transfer medium 50 to heat the transfer medium 50. Also, the heater 216 is a heater (after heater) arranged on the downstream side of the head unit 102 in the transport direction. The heated member 218 is a member heated by the heater 216, and by contacting the transfer medium 50, transmits the heat of the heater 216 to the transfer medium 50 to heat the transfer medium 50. As shown in the figure, the heated member 214 and the heated member 218 are arranged at positions adjacent to the platen 104 in the transport direction, and the heat generated by the heater 212 and the heater 216 is also transmitted to the platen 104. That is, the heating means 112, as described above, also applies heat to the platen 104 to heat the transfer medium 50 via the platen 104. As shown in the figure, it can also be considered that the heated member 214 and the heated member 218 support the transfer medium 50 at positions facing the head unit 102. That is, it can also be considered that the heated member 214 and the heated member 218 constitute a part of the platen 104.

Next, the operation of printing performed using the color head 202 and the white ink head 204 will be described in more detail. As described above, when performing printing by a transfer method, the printing device 12 draws an image on the transfer medium 50 using transfer color ink, and forms a layer of ink of a predetermined color such as white thereon. The layer of ink of a predetermined color such as white is considered to function as a background of the image after transfer, for example. The printing device 12 of the example forms a color ink layer, which is an ink layer formed with color ink, on the transfer medium 50, and forms a white ink layer, which is an ink layer formed with white ink, thereon. The color ink layer is an example of a layer on which an image is drawn with color ink. The white ink layer is an example of a layer that functions as a background of the image after transfer. The white ink can also be considered as an example of light reflective ink. The white ink layer can also be considered as a light reflective ink layer. Moreover, the white ink layer can also be considered as a layer for concealing the color of the transferred medium 150 (see FIG. 1) after transfer. In this case, the printing device 12 needs to discharge ink from the head unit 102 so that the color ink and the white ink do not mix on the transfer medium 50.

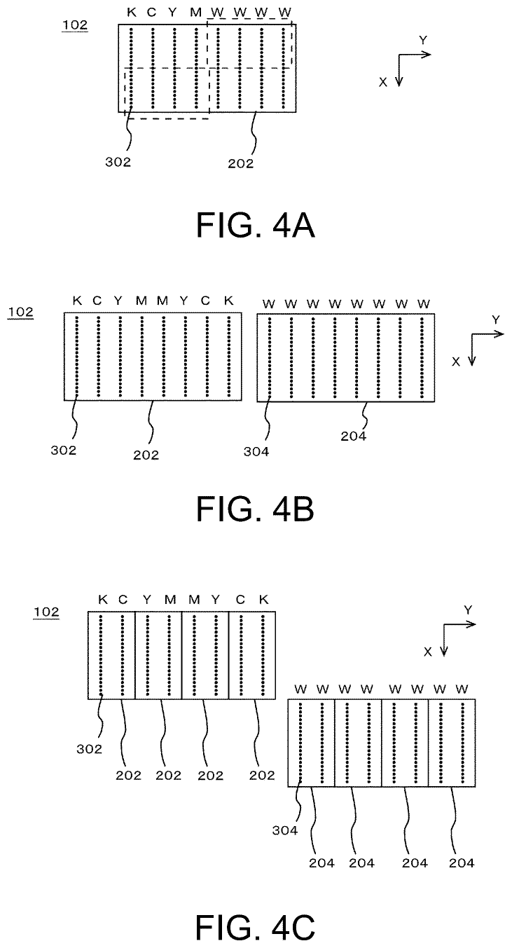

As described above, the printing device 12 of the example discharges ink from the head unit 102 to each of positions of the transfer medium 50 by causing the head unit 102 to perform the main scanning operation and sub-scanning operation. In this case, ink discharged from nozzle rows of which positions are aligned in the sub-scanning direction, such as the nozzle rows 302 for each of the colors (see FIG. 2) in the color head 202 of the head unit 102, normally becomes easy to mix on the transfer medium 50. In contrast, as described above, the white ink head 204 of the head unit 102 of the example is arranged with a position shifted in the sub-scanning direction relative to the color head 202. That is, the range where the white ink head 204 discharges ink and the range where the color head 202 discharges ink in one main scanning operation performed simultaneously do not overlap. Therefore, according to the example, white ink can be discharged from the white ink head 204 while preventing color ink and white ink from mixing on the transfer medium 50. In this way, a white ink layer can be appropriately formed on the color ink layer. Furthermore, as will be described below using FIG. 4, printing to the transfer medium 50 can be performed while preventing a decrease in printing speed that occurs due to using the white ink head 204.

FIG. 4 is a diagram for describing features of the head unit 102 of the example and modified examples of the configuration of the head unit 102. FIGS. 4(a) and (b) are diagrams for describing printing operations when using the head unit 102 having a configuration different from the head unit 102 of the example. When performing transfer printing, as described above, white ink is often used in addition to color ink. In this case, it is usually needed to discharge white ink from any of the inkjet heads in the head unit 102. If simply considering discharging white ink, for example, as shown in FIG. 4(a), it is also conceivable to allocate some nozzle rows in the color head 202 that discharges color ink for white ink.

However, when printing is performed using all nozzles of the nozzle row 302, it is considered that the color ink and the white ink may mix on the transfer medium 50. As a result, it becomes difficult to appropriately form the white ink layer overlapping the color ink layer. Therefore, for example, when the color head 202 is used as shown in FIG. 4(a), by not using the nozzles in the range shown sandwiched by broken lines in the figure, merely about half of all nozzles are used to perform printing on the transfer medium 50. And in this case, by performing printing using merely a partial range of the nozzle row 302, the printing speed decreases compared to the case where the entire nozzle row 302 is used.

When using the white ink head 204 in addition to the color head 202, for example, as shown in FIG. 4(b), it is also conceivable to arrange the color head 202 and the white ink head 204 with positions aligned in the sub-scanning direction. However, in this case as well, when attempting to form a white ink layer overlapping the color ink layer, the same problem as in the case of the configuration shown in FIG. 4(a) will occur. Therefore, in this case as well, it is usually needed to use merely the nozzles in half the range in the sub-scanning direction for the nozzle row 302 in the color head 202 and the nozzle row 304 in the white ink head 204. As a result, in this case as well, the printing speed will decrease.

In contrast, as in the example, when the color head 202 and the white ink head 204 are arranged with positions shifted in the sub-scanning direction, all nozzles of the color head 202 and the white ink head 204 can be used to perform printing on the transfer medium 50. Using all nozzles may mean using substantially all nozzles (almost all nozzles), excluding a small number of some nozzles that are not used due to convenience of printing operation control and the like. Therefore, according to the example, even when forming a white ink layer overlapping the color ink layer, printing on the transfer medium 50 can be appropriately performed while preventing a decrease in printing speed.

The specific configuration of the head unit 102 is not limited to the configuration shown in FIG. 2(b), and various modifications may also be made. For example, it is also conceivable to arrange the color head 202 and the white ink head 204 with an interval in the sub-scanning direction. When the interval between the color head 202 and the white ink head 204 is widened, the time from discharging color ink to discharging white ink at each of the positions of the transfer medium 50 increases, which becomes advantageous in terms of ink drying and can more appropriately prevent bleeding between ink. However, more installation space for the head unit 102 and space for the printing surface are required, and it is conceivable that the printing device 12 becomes larger. Therefore, when widening the interval between the color head 202 and the white ink head 204 in the sub-scanning direction, it is preferable to set the interval with attention to the above points.

As described above, FIG. 2(b) illustrated a configuration in which the head unit 102 has one color head 202 and one white ink head 204. However, the head unit 102 may have multiple color heads 202 and multiple white ink heads 204, for example, as shown in FIG. 4(c). FIG. 4(c) shows a modified example of the configuration of the head unit 102. The head unit 102 shown in FIG. 4(c) has four color heads 202 and four white ink heads 204. In the modified example, the color heads 202 in the head unit 102 are aligned in positions in the sub-scanning direction and arranged in the main scanning direction. The white ink heads 204 are aligned in positions in the sub-scanning direction and arranged in the main scanning direction. The color head 202 of the illustrated configuration has two nozzle rows 302. The white ink head 204 has two nozzle rows 304. Even when configured in this way, by arranging the color head 202 and the white ink head 204 with positions shifted in the sub-scanning direction, when forming a white ink layer overlapping the color ink layer, printing to the transfer medium 50 can be appropriately performed while preventing a decrease in printing speed. In a further modified example of the configuration of the head unit 102, for example, a color head 202 having merely one nozzle row 302 and a white ink head 204 having merely one nozzle row 304 may be used. Also, the number of color heads 202 and the number of white ink heads 204 that the head unit 102 has may be different. For example, it is conceivable to make the number of white ink heads 204 smaller than the number of color heads 202.

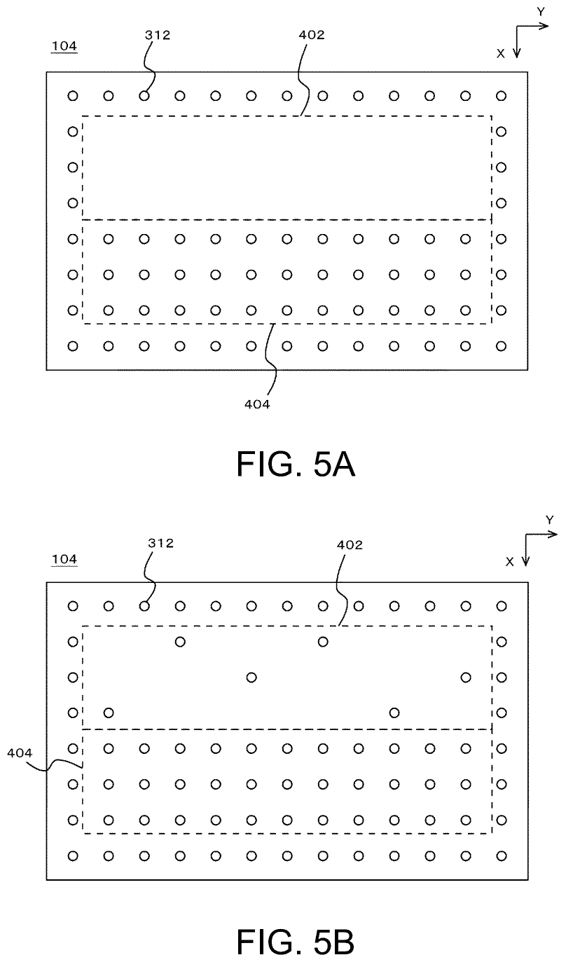

As described above, the heating means 112 (see FIG. 2) of the example heats the transfer medium 50 via the platen 104. And, as in the example, when the color head 202 and the white ink head 204 are arranged with the positions shifted in the sub-scanning direction, the range on the platen 104 (see FIG. 2) that faces the color head 202 and the range that faces the white ink head 204 become different ranges. Therefore, it is also conceivable to make the heating condition for the range on the platen 104 that faces the color head 202 different from the heating condition for the range that faces the white ink head 204. For example, as in the example, when using the platen 104 in which suction holes are formed, it is conceivable that a temperature difference occurs in the cavity portions of the holes compared to surroundings thereof. Therefore, for example, by making the presence or absence of suction holes or the density of suction holes different depending on an area on the platen 104, the heating condition for each of areas can be made different. In this case, it is conceivable to form the suction holes of the platen 104 as shown in FIG. 5, for example.

FIG. 5 is a diagram for describing a method of forming suction holes 312 in the platen 104. FIG. 5(a) shows an example of the configuration of the platen 104. Regarding the method of forming the suction holes 312 in the platen 104, the inventors of the present application confirmed through experiments measuring the temperature at each of the positions of the transfer medium 50 (see FIG. 1) held on the platen 104 that the temperature at the positions of the suction holes 312 decreases compared to the surroundings. In the experiment, it was confirmed that the temperature decreases by about 10 degrees (8 degrees or more) at the positions of the suction holes 312. The temperature difference is considered to occur due to, for example, differences in thermal conductivity at the positions of the suction holes 312 of the platen 104 compared to the surroundings.

When performing printing using inkjet heads such as the color head 202 and white ink head 204 (see FIG. 2), ink that has landed on the transfer medium 50 normally spreads in a dot-like manner on the transfer medium 50 during the period until the ink is fixed to the transfer medium 50. And the manner in which the ink spreads on the transfer medium 50 can be influenced by the temperature of the transfer medium 50. Therefore, when a temperature decrease occurs at the position of the suction hole 312, it is conceivable that the spreading manner of the ink dots until fixing to the transfer medium 50 does not become the spreading manner assumed in the design. Also, it is conceivable that the position of the suction hole 312 becomes a locally low temperature portion, and by generating a temperature difference compared to the surroundings, unevenness occurs in the dot spreading manner, and the print quality deteriorates. Also, the inventors of the present application confirmed by actually performing experiments that unevenness (vertical unevenness) in printing results tends to occur due to the influence of the suction holes 312. That is, when considering preventing deterioration of print quality due to the influence of suction holes, it is preferable not to use the suction holes 312 as much as possible. However, when considering appropriately holding the transfer medium 50 during the main scanning operation, it can also be said that it is preferable to use a certain number of suction holes 312.

The problem of unevenness as described above becomes particularly problematic when drawing images with color ink. In contrast, for example, when forming an ink layer with merely white ink, unevenness is less likely to be a problem. Since the white ink layer comes under the color ink layer after transfer, unevenness is less likely to be a problem in that respect as well. Based on this, it is conceivable to make the method of forming suction holes different between the position facing the color head 202 on the platen 104 and the position facing the white ink head 204. By configuring in this way, the heating conditions under which the heating means 112 (see FIG. 2) heats the transfer medium 50 via the platen 104 can be made different between the position facing the color head 202 on the transfer medium 50 and the position facing the white ink head 204. In this case, it is conceivable to form as few suction holes as possible at the position facing the color head 202. Moreover, it is more preferable not to form suction holes at the position facing the color head 202.

In this case, for example, as shown in FIG. 5(a), it is conceivable not to form the suction holes 312 in a passage area 402, which is an area on the platen 104 through which the color head 202 passes during the main scanning operation. And, it is conceivable to form a necessary number of the suction holes 312 in a passage area 404, which is an area on the platen 104 through which the white ink head 204 passes during the main scanning operation. The passage area 402 and passage area 404 in the example are adjacent to each other in the sub-scanning direction. With this configuration, the transfer medium 50 can be appropriately held on the platen 104 while appropriately preventing the influence of the suction holes 312 from occurring at positions facing the color head 202. In this way, occurrence of unevenness such as vertical unevenness can be appropriately prevented, and printing with high quality can be performed. When considering merely reducing the influence of the suction holes 312, it might seem more preferable not to form the suction holes 312 in the passage area 404 of the white ink head 204 as well. However, in that case, the number of the suction holes 312 on the platen 104 becomes too small, making it difficult to hold the transfer medium 50 with high accuracy. In contrast, in the example, by forming the suction holes 312 in the passage area 402 of the white ink head 204, the transfer medium 50 can be held more reliably.

As described above, the color head 202 and the white ink head 204 of the example discharge ink while moving in the main scanning direction during the main scanning operation. The passage area 402 and the passage area 404 correspond to areas where the color head 202 and the white ink head 204 can discharge ink during the main scanning operation. When an area where the color head 202 can discharge ink in one main scanning operation is defined as a color ink discharge area, and an area where the white ink head 204 can discharge ink in one main scanning operation is defined as a white ink discharge area, the passage area 402 of the color head 202 is a range that overlaps with the color ink discharge area on the platen 104. The passage area 404 of the white ink head 204 is a range that overlaps with the white ink discharge area on the platen 104. The color ink discharge area is an example of a first discharge area. The white ink discharge area is an example of a second discharge area. In this way, by making the formation method of the suction holes 312 (presence or absence of the suction holes 312) different in the passage area 402 and the passage area 404, the heating means 112 (see FIG. 2) and the platen 104 of the printing device 12 can heat the transfer medium 50 with different temperature distributions between the color ink discharge area and the white ink discharge area. Therefore, according to the example, heating conditions for the transfer medium 50 can be appropriately made different between a position on the transfer medium 50 facing the color head 202 and a position facing the white ink head 204.

The heating condition of the example can also be considered as a condition that makes the temperature distribution in the color ink discharge area distribution in which unevenness and the like are less likely to occur in the printing result than the temperature distribution in the white ink discharge area. Also, the temperature distribution in the color ink discharge area can also be considered as distribution in which portions where the temperature becomes locally low are reduced compared to the temperature distribution in the white ink discharge area. Also, it can be considered that the temperature distribution in the color ink discharge area is more uniform distribution than the temperature distribution in the white ink discharge area. Also, the passage area 402 of the color head 202 can be considered to have a width in the main scanning direction smaller than the width of the platen 104, for example, as shown in the figure. In this case, for example, as shown in the figure, in the range of the platen 104 in the sub-scanning direction, among the portions that overlap with the passage area 402 of the color head 202, the suction holes 312 can be formed as necessary in the portions that are outside the passage area 402 in the main scanning direction. With this configuration, the transfer medium 50 on the platen 104 can be held more reliably.

Also, depending on the quality and the like required for printing, instead of not forming the suction holes 312 at all in the passage area 402 of the color head 202, for example, as shown in FIG. 5(b), it is also conceivable to form a small number of the suction holes 312. FIG. 5(b) shows another example of the configuration of the platen 104. The example of FIG. 5(b) is an example of a configuration in which the number of the suction holes 312 in the range overlapping with the color ink discharge area 402 on the platen 104 is minimized as much as possible. Even when configured in this way, the influence of the suction holes 312 on print quality can be reduced. In this way, printing with higher quality can be performed.

As shown in FIGS. 5(a) and (b), the configuration for forming the suction holes 312 can also be considered by focusing on the density of the suction holes 312. For example, when the number of the suction holes 312 per unit area is defined as a suction hole density, regarding the method of forming the suction holes 312 in the platen 104, it can also be considered that the suction hole density of the passage area 402 of the color head 202 is made smaller than the suction hole density of the passage area 404 of the white ink head 204. In this case, by making the suction hole densities different, it can be considered that the heating means 112 and the platen 104 make the temperature distribution in the color ink discharge area different from the temperature distribution in the white ink discharge area. In this case, by making the suction hole density in the passage area 402 of the color head 202 small, unevenness due to the influence of the suction holes 312 on images drawn with color ink may be made less likely to occur. The configuration of making the suction hole density in the passage area 402 of the color head 202 small is a particularly preferable configuration when the difference between the temperature at the suction holes 312 and the surrounding temperature is large. More specifically, when focusing on the temperature decrease that occurs at the positions of the suction holes 312 formed in the passage area 404 of the white ink head 204, the heating means 112 of the example heats the platen 104 under conditions where the temperature at the center of the suction holes 312 becomes 8 degrees or more lower than the temperature around the suction holes.

Also, in the platen 104, it is conceivable that local temperature changes (for example, temperature decrease) may occur due to factors other than the suction holes 312. For example, when screws are used in the platen 104, it is conceivable that the thermal conductivity at the positions of the screw holes differs from the surroundings, causing temperature unevenness. Therefore, it is more preferable that screw holes are also not formed in the passage area 402 of the color head 202 in the platen 104. When focusing on holes such as the suction holes 312 and screw holes, it is preferable that the platen 104 has fewer hole-shaped configurations disposed in the passage area 402 of the color head 202 than the same configurations disposed in the passage area 404 of the white ink head 204. It is more preferable that hole-shaped configurations are not formed in the passage area 402 of the color head 202.

Subsequently, supplementary descriptions and the like regarding each of the configurations described above will be provided. As described above, the printing device 12 of the example executes printing operations on the transfer medium 50 using the head unit 102 (see FIG. 2) having the color head 202 and the white ink head 204. Then, for each of the positions of the transfer medium 50, after color ink is discharged from the color head 202, white ink is discharged from the white ink head 204. The white ink head 204 is an inkjet head that discharges ink that is discharged later than the color ink to an image printing area. In this case, the image printing area is an area in the transfer medium 50 where color ink is discharged.

As a modified example of the configuration of the printing device 12, it is conceivable to use an inkjet head that discharges ink of a color other than white as an inkjet head other than the color head 202. In this case, the inkjet head is an example of a second inkjet head. In this case, it is conceivable to use an inkjet head that discharges ink for forming an ink layer that serves as a background of an image as an inkjet head other than the color head 202. The ink discharged by the inkjet head other than the color head 202 can also be considered as ink of a color determined according to the quality required for printing, the purpose of printing, etc. When using an inkjet head other than the color head 202, the inkjet head may discharge ink to each of the positions of the transfer medium 50, for example, before the color ink. It is also conceivable to further use an inkjet head for other colors in addition to the white ink head 204 as an inkjet head other than the color head 202. In this case, it is conceivable to arrange the color head 202, the white ink head 204, and the inkjet head for other colors with positions in the sub-scanning direction shifted from each other. Such a configuration can also be considered as a configuration of a staggered arrangement of three or more stages.

As described above, the platen 104 of the example performs more uniform heating to the color ink discharge area in the transfer medium 50 by not forming the suction holes 312 (see FIG. 5) in the passage area 402 of the color head 202. Regarding this point, when focusing on making the heating conditions different for the color ink discharge area and the white ink discharge area, for example, it is also conceivable to make the heating conditions different by adjusting the temperature itself at which the heating means 112 heats the platen 104. In this case, for example, it is conceivable to appropriately adjust the temperature of heaters that the heating means 112 has, such as the heater 212 and heater 216 in the configuration shown in FIG. 3, to make the temperature in the passage area 402 of the color head 202 on the platen 104 higher than the temperature in the passage area 404 of the white ink head 204. Even when configured in this way, the heating conditions for the color ink discharge area and the white ink discharge area can be appropriately made different. In this way, the conditions for drying the color ink and the conditions for drying the white ink can be appropriately made different according to the fixing method or the like required for the color ink and the white ink.

In the above, the printing system 10 has been described mainly in terms of a configuration for performing transfer printing. In contrast, as a modified example of the configuration of the printing system 10, it is conceivable to perform printing by methods other than the transfer method. For example, it is conceivable that the printing device 12 performs printing on media other than the transfer medium 50. Even in such cases, multiple inkjet heads that are arranged with positions shifted in the sub-scanning direction may be used, such as the color head 202 and the white ink head 204 in the example. Also, as the platen 104, it is conceivable to use the platen 104 having a configuration in which the suction holes 312 in the passage area 402 of the color head 202 are reduced, such as the configuration shown in FIG. 5. Even when configured in this way, unevenness due to the influence of the suction holes 312 on images drawn with color ink can be made less likely to occur.

Also, in the above embodiment, the configuration in which the printing device 12 uses evaporation drying type ink was mainly described. Here, heating by the heating means 112 is an example of heating for drying ink. In contrast, as a modified example of the configuration of the printing system 10, it is also conceivable that the printing device 12 uses ink other than the evaporation drying type. In this case as well, the printing device 12 may heat the medium via the platen 104 by the heating means 112. For example, it is also conceivable that the printing device 12 uses ultraviolet curing type ink or the like. In this case as well, it is conceivable to perform heating for adjusting the temperature of the medium to a predetermined temperature by the heating means 112. With this configuration, ink can be cured at a constant temperature. In this way, printing with desired quality can be performed more appropriately. Also, in this case as well, it is conceivable to use multiple inkjet heads arranged with positions shifted in the sub-scanning direction, such as the color head 202 and the white ink head 204 of the example. Also, as the platen 104, it is conceivable to use the platen 104 having a configuration in which the suction holes 312 in the passage area 402 of the color head 202 are reduced, such as the configuration shown in FIG. 5. With this configuration, color ink discharged from the color head 202 can be cured under more uniform conditions. In this way, unevenness due to the influence of the suction holes 312 on images drawn with color ink can be made less likely to occur.

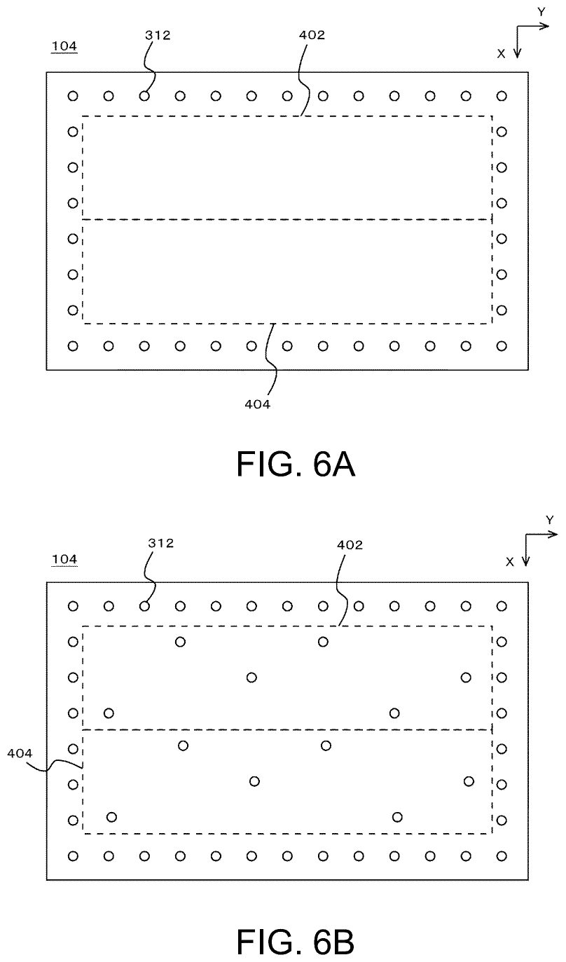

In addition, for example, as shown in FIG. 6(a), no suction holes 312 are provided in the passage area 402 and passage area 404 of the platen 104, and the transfer medium 50 is suctioned by the suction holes 312 in areas adjacent to the passage area 402 and passage area 404. Alternatively, if some suction holes 312 are needed in the passage area 402 and passage area 404, as shown in FIG. 6(b), the minimum needed suction holes 312 may be provided in the passage area 402 and passage area 404. Even with such a configuration, the occurrence of vertical unevenness caused by the suction holes 312 can be suppressed, and deterioration of print quality can be prevented.

### Industrial Applicability

The present invention can be suitably used, for example, in a printing device.

### Reference Signs List

10 . . . printing system, 102 . . . head unit, 104 . . . platen, 106 . . . Y bar unit, 108 . . . main scanning drive unit, 110 . . . sub-scanning drive unit, 112 . . . heating means, 114 . . . suction means, 12 . . . printing device, 120 . . . control unit, 14 . . . control device, 150 . . . transferred medium, 16 . . . powder coating device, 18 . . . transfer device, 202 . . . color head, 204 . . . white ink head, 206 . . . transport roller, 208 . . . pinch roller, 212 . . . heater, 214 . . . heated member, 216 . . . heater, 218 . . . heated member, 222 . . . roll holder, 224 . . . paper tube, 302 . . . nozzle row, 304 . . . nozzle row, 312 . . . suction hole, 402 . . . passage area, 404 . . . passage area, 50 . . . transfer medium, 52 . . . film layer, 54 . . . peeling layer, 56 . . . receptor layer, 62 . . . ink layer, 64 . . . powder layer

1. A printing device which performs printing on a film-shaped transfer medium using an inkjet method, comprising:
a head unit, discharging ink to the medium;
a main scanning drive unit, causing the head unit to perform a main scanning operation of discharging ink while moving relatively to the medium in a preset main scanning direction; and
a sub-scanning drive unit, causing the head unit to perform a sub-scanning operation of moving relatively to the medium in a sub-scanning direction orthogonal to the main scanning direction, and
the head unit comprising
a first inkjet head that discharges color ink which is ink of a predetermined colored color, and
a second inkjet head arranged with a position shifted from the first inkjet head in the sub-scanning direction.

2. The printing device according to claim 1, further comprising:
a platen, supporting the medium at a position facing the head unit; and
a heating means, heating the medium via the platen by applying heat to the platen, and
when an area where the first inkjet head is able to discharge ink in the main scanning operation of one time is defined as a first discharge area, and an area where the second inkjet head is able to discharge ink in the main scanning operation of one time is defined as a second discharge area,
the heating means and the platen
heating the medium by making temperature distribution in the first discharge area different from temperature distribution in an area adjacent thereto, or
heating the medium by making temperature distribution in the first discharge area and the second discharge area different from temperature distribution in areas adjacent to the first discharge area and the second discharge area.

3. The printing device according to claim 2, wherein the heating means and the platen heat the medium by making the temperature distribution in the first discharge area different from the temperature distribution in the second discharge area.

4. The printing device according to claim 3, wherein
the sub-scanning drive unit moves the head unit relatively to the medium by transporting the medium in a transport direction parallel to the sub-scanning direction,
suction holes for suctioning the medium are formed in the platen, and
when the number of the suction holes per unit area is defined as a suction hole density,
the suction hole density in a range overlapping with the first discharge area is smaller than the suction hole density in a range overlapping with the second discharge area,
whereby the heating means and the platen make the temperature distribution in the first discharge area different from the temperature distribution in the second discharge area.

5. The printing device according to claim 4, wherein in the platen, the suction holes are not formed in a range overlapping with the first discharge area, and the suction holes are formed in a range overlapping with the second discharge area.

6. A printing device which performs printing using an inkjet method, comprising:
a head unit, discharging ink to a medium;
a main scanning drive unit, causing the head unit to perform a main scanning operation of discharging ink while moving relatively to the medium in a preset main scanning direction;
a sub-scanning drive unit, causing the head unit to perform a sub-scanning operation of moving relatively to the medium in a sub-scanning direction orthogonal to the main scanning direction;
a platen, supporting the medium at a position facing the head unit; and
a heating means, heating the medium via the platen by applying heat to the platen, and
the head unit comprising
a first inkjet head and
a second inkjet head arranged with a position shifted from the first inkjet head in the sub-scanning direction,
the sub-scanning drive unit moving the head unit relatively to the medium by transporting the medium in a transport direction parallel to the sub-scanning direction,
suction holes for suctioning the medium being formed in the platen, and
when an area where the first inkjet head is able to discharge ink in the main scanning operation of one time is defined as a first discharge area, and an area where the second inkjet head is able to discharge ink in the main scanning operation of one time is defined as a second discharge area,
the heating means and the platen
heating the medium by making temperature distribution in the first discharge area different from temperature distribution in an area adjacent thereto, or
heating the medium by making temperature distribution in the first discharge area and the second discharge area different from temperature distribution in areas adjacent to the first discharge area and the second discharge area.

7. The printing device according to claim 6, wherein the heating means and the platen heat the medium by making the temperature distribution in the first discharge area different from the temperature distribution in the second discharge area.

8. The printing device according to claim 7, wherein
when the number of the suction holes per unit area of the platen is defined as a suction hole density,
the suction hole density in a range overlapping with the first discharge area is smaller than the suction hole density in a range overlapping with the second discharge area.

9. A printing method which performs printing by the printing device according to claim 1.

10. A printing method which performs printing by the printing device according to claim 6.

11. The printing method according to claim 10, wherein the heating means and the platen heat the medium by making the temperature distribution in the first discharge area different from the temperature distribution in the second discharge area.

12. The printing method according to claim 11, wherein
when the number of the suction holes per unit area of the platen is defined as a suction hole density,
the suction hole density in a range overlapping with the first discharge area is smaller than the suction hole density in a range overlapping with the second discharge area.

13. A printing system which performs printing on a film-shaped transfer medium, comprising:
a printing device, performing printing on the medium using an inkjet method;
a powder coating device, applying adhesive powder to the medium on which an image has been printed by the printing device; and
a transfer device, transferring the image drawn on the medium to which the powder has been applied by the powder coating device to a transferred medium, and
the medium comprising
a thin film layer,
a receptor layer which is a layer that receives transfer ink, and
a peeling layer which releasably bonds the film layer and the receptor layer,
the printing device comprising
a head unit which discharges ink to the medium,
a main scanning drive unit which causes the head unit to perform a main scanning operation of discharging ink while moving relatively to the medium in a preset main scanning direction, and
a sub-scanning drive unit which causes the head unit to perform a sub-scanning operation of moving relatively to the medium in a sub-scanning direction orthogonal to the main scanning direction, and
the head unit comprising
a first inkjet head that discharges color ink which is ink of a predetermined colored color, and
a second inkjet head arranged with a position shifted from the first inkjet head in the sub-scanning direction.

14. The printing system according to claim 13, wherein
the second inkjet head discharges light reflective ink,
the sub-scanning drive unit moves the head unit relatively to the medium by transporting the medium in a transport direction parallel to the sub-scanning direction, and
the second inkjet head is arranged on a downstream side in the transport direction with respect to the first inkjet head.

15. The printing method according to claim 9, further comprising:
supporting the medium at a position facing the head unit by a platen; and
heating the medium via the platen by applying heat to the platen by a heating means, and
when an area where the first inkjet head is able to discharge ink in the main scanning operation of one time is defined as a first discharge area, and an area where the second inkjet head is able to discharge ink in the main scanning operation of one time is defined as a second discharge area,
the heating means and the platen
heating the medium by making temperature distribution in the first discharge area different from temperature distribution in an area adjacent thereto, or
heating the medium by making temperature distribution in the first discharge area and the second discharge area different from temperature distribution in areas adjacent to the first discharge area and the second discharge area.

16. The printing method according to claim 15, wherein the heating means and the platen heat the medium by making the temperature distribution in the first discharge area different from the temperature distribution in the second discharge area.

17. The printing method according to claim 16, wherein
the sub-scanning drive unit moves the head unit relatively to the medium by transporting the medium in a transport direction parallel to the sub-scanning direction,
suction holes for suctioning the medium are formed in the platen, and
when the number of the suction holes per unit area is defined as a suction hole density,
the suction hole density in a range overlapping with the first discharge area is smaller than the suction hole density in a range overlapping with the second discharge area,
whereby the heating means and the platen make the temperature distribution in the first discharge area different from the temperature distribution in the second discharge area.

18. The printing method according to claim 17, wherein in the platen, the suction holes are not formed in a range overlapping with the first discharge area, and the suction holes are formed in a range overlapping with the second discharge area.

19. The printing system according to claim 13, wherein the printing device further comprising:
a platen, supporting the medium at a position facing the head unit; and
a heating means, heating the medium via the platen by applying heat to the platen, and
when an area where the first inkjet head is able to discharge ink in the main scanning operation of one time is defined as a first discharge area, and an area where the second inkjet head is able to discharge ink in the main scanning operation of one time is defined as a second discharge area,
the heating means and the platen
heating the medium by making temperature distribution in the first discharge area different from temperature distribution in an area adjacent thereto, or
heating the medium by making temperature distribution in the first discharge area and the second discharge area different from temperature distribution in areas adjacent to the first discharge area and the second discharge area.

20. The printing system according to claim 19, wherein the heating means and the platen heat the medium by making the temperature distribution in the first discharge area different from the temperature distribution in the second discharge area.
